(19) United States
(12) Patent Application Publication
(10) Pub. No.: US 2024/0421903 A1
(43) Pub. Date: Dec. 19, 2024

(54) FREE-SPACE OPTICAL COMMUNICATION APPARATUS, FREE-SPACE OPTICAL COMMUNICATION SYSTEM, FREE-SPACE OPTICAL COMMUNICATION METHOD, AND RECORDING MEDIUM

(71) Applicant: NEC Corporation, Tokyo (JP)

(72) Inventor: Yohei HASEGAWA, Tokyo (JP)

(73) Assignee: NEC Corporation, Tokyo (JP)

(21) Appl. No.: 18/744,979

(22) Filed: Jun. 17, 2024

(30) Foreign Application Priority Data
Jun. 19, 2023 (JP) 2023-100126

(51) Int. Cl. H04B 10/11

(52) U.S. Cl. CPC H04B 10/11

(57) ABSTRACT

A free-space optical communication technique is provided for effectively reducing the occurrence of burst errors caused by the attenuation or loss of packets. A free-space optical communication apparatus includes a light sending and receiving section configured to send and receive communication light and a communication control section configured to control packet communication. The communication control section causes the light sending and receiving section to send either a given packet or first coded information, and then causes the light sending and receiving section to send second coded information which contains the given packet and a packet received by the light sending and receiving section at a point in time at which a first predetermined time elapses.

### CROSS REFERENCE TO RELATED APPLICATIONS

This application is based upon and claims the benefit of priority from Japanese Patent Application No. 2023-100126 filed on Jun. 19, 2023, the disclosure of which is incorporated herein in its entirety by reference.

### TECHNICAL FIELD

The present invention relates to a free-space optical communication apparatus, a free-space optical communication system, a free-space optical communication method, and a recording medium.

### BACKGROUND ART

In recent years, communication traffic on the Internet, a mobile net, or the like has been increasing at a remarkable annual rate which is as high as 20% to 40%. It is therefore desirable to put a free-space optical communications (FSOC)-based network to practical use. Free-space optical communication is high-speed wireless communication conducted through free space with use of laser light as a transmission medium of communication signals, the laser light having wavelengths of those of visible to infrared rays. In recent years, free-space optical communication has achieved a wireless communication speed close to that of fiber communication.

Incidentally, in free-space optical communication, a communication signal attenuates and becomes lost due to natural phenomena such as atmospheric fluctuation, rain, high winds, and earthquakes, and a burst error occurs accordingly. A burst error is the main cause of impairment of the reliability of free-space optical communication. In order to address, various techniques have been studied and developed to provide highly reliable free-space optical communication. For example, Patent Literature 1 discloses an example technique for providing highly reliable free-space optical communication.

### CITATION LIST

### Patent Literature

### Patent Literature 1

Japanese Patent Application Publication Tokukaihei No. 10-135909

### SUMMARY OF INVENTION

### Technical Problem

The technique disclosed in Patent Literature 1 is useful as a technique for addressing the blockage of laser light due to the intervention of an obstacle or the like. However, this technique does not address the attenuation and loss of a communication signal, and is therefore not necessarily sufficient for a reduction in the occurrence of burst errors caused by the attenuation or loss of a communication signal.

An example object of an example aspect of the present invention is to provide a free-space optical communication technique for effectively reducing the occurrence of burst errors caused by attenuation or loss of a communication signal.

### Solution to Problem

A free-space optical communication apparatus in accordance with an example aspect of the present invention includes: a light sending and receiving section configured to send and receive communication light; and at least one processor, the at least one processor carries out a communication control process of controlling packet communication conducted via the light sending and receiving section, and in the communication control process, the at least one processor causes the light sending and receiving section to send either a first packet or first coded information, the first packet being received by the light sending and receiving section, the first coded information containing the first packet and being generated by network coding, and then causes the light sending and receiving section to send second coded information containing the first packet and a second packet and generated by network coding, the second packet being received by the light sending and receiving section at a point in time at which a first predetermined time elapses from a point in time at which either the first packet or the first coded information is sent.

A free-space optical communication system in accordance with an example aspect of the present invention includes a plurality of free-space optical communication apparatuses, at least two free-space optical communication apparatuses of the plurality of free-space optical communication apparatuses each include: a light sending and receiving section configured to send and receive communication light; and at least one processor, the at least one processor carries out a communication control process of controlling packet communication conducted via the light sending and receiving section, and in the communication control process, the at least one processor causes the light sending and receiving section to send either a first packet or first coded information, the first coded information containing the first packet and being generated by network coding, and then causes the light sending and receiving section to send second coded information containing the first packet and a second packet and generated by network coding, the second packet being received by the light sending and receiving section at a point in time at which a first predetermined time elapses from a point in time at which either the first packet or the first coded information is sent.

A free-space optical communication method in accordance with an example aspect of the present invention is a free-space optical communication method including at least one processor carrying out a packet communication control process via a light sending and receiving section for sending and receiving communication light, and in the packet communication control process, the at least one processor causes the light sending and receiving section to send either a first packet or first coded information, the first coded information containing the first packet and being generated by network coding, and then causes the light sending and receiving section to send second coded information containing the first packet and a second packet and generated by network coding, the second packet being received by the light sending and receiving section at a point in time at which a first predetermined time elapses from a point in time at which either the first packet or the first coded information is sent.

An example aspect of the present invention is a computer-readable non-transitory recording medium having recorded thereon a program for causing a computer to operate as the free-space optical communication apparatus, the program causing the computer to carry out the communication control process.

### Advantageous Effects of Invention

According to an example aspect of the present invention, it is possible to provide a free-space optical communication technique for effectively reducing the occurrence of burst errors caused by the attenuation or loss of packets.

### BRIEF DESCRIPTION OF DRAWINGS

FIG. 1 is a block diagram illustrating a configuration of a free-space optical communication system which includes free-space optical communication apparatuses in accordance with a first example embodiment of the present invention.

FIG. 2 is a flowchart illustrating a flow of a free-space optical communication method in accordance with the first example embodiment of the present invention.

FIG. 3 is a block diagram illustrating a configuration of a free-space optical communication system which includes free-space optical communication apparatuses in accordance with second and third example embodiments of the present invention.

FIG. 4 is a block diagram illustrating a configuration of a light sending and receiving section included in the free-space optical communication apparatus in accordance with the second example embodiment of the present invention.

FIG. 5 is a representation illustrating a process of setting a first predetermined time, the process being carried out by a communication control section of the free-space optical communication apparatus in accordance with the second example embodiment of the present invention.

FIG. 6 is a representation illustrating a principle of packet communication conducted by the free-space optical communication system in accordance with the second example embodiment of the present invention.

FIG. 7 is a representation illustrating an example of a coded information sending process carried out by the communication control section.

FIG. 8 is a flowchart illustrating a flow of a free-space optical communication method in accordance with the second example embodiment of the present invention.

FIG. 9 is a representation illustrating a variation of the coded information sending process carried out by the communication control section.

FIG. 10 is a representation illustrating a distinctive process carried out by a communication control section of the free-space optical communication apparatus in accordance with the third example embodiment of the present invention.

FIG. 11 is a flowchart illustrating a flow of the distinctive process.

FIG. 12 is a block diagram illustrating a hardware configuration of a computer, which is an example implementation of the free-space optical communication apparatus of each of the example embodiments of the present invention.

### EXAMPLE EMBODIMENTS

### First Example Embodiment

The following description will discuss a first example embodiment of the present invention in detail, with reference to the drawings. The present example embodiment is basic to example embodiments which will be described later.

### <Configuration of Free-Space Optical Communication System 100>

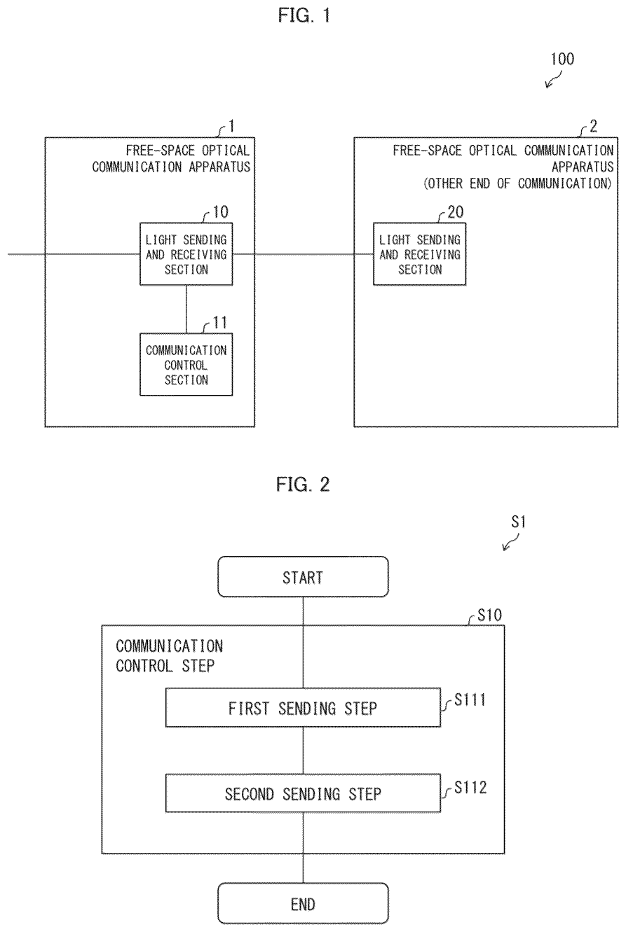

Here is a description of a configuration of a free-space optical communication system which includes free-space optical communication apparatuses in accordance with the present example embodiment, provided with reference to FIG. 1. FIG. 1 is a block diagram illustrating a configuration of a free-space optical communication system 100. The free-space optical communication system 100 includes: two free-space optical communication apparatuses which are a free-space optical communication apparatus 1 and a free-space optical communication apparatus 2; and an additional free-space optical communication apparatus (not illustrated), to provide spatial multiplexing transmission by simultaneous connection of multiple signals of communication light. The free-space optical communication system 100 uses packet communication as the communication scheme of free-space optical communication. Although illustrated in FIG. 1 is an example in which the free-space optical communication system 100 includes the two free-space optical communication apparatuses 1 and 2, the number of free-space optical communication apparatuses included in the free-space optical communication system 100 is not limited to the example in FIG. 1.

In the following description, the free-space optical communication apparatus 1 is a free-space optical communication apparatus of interest, and the free-space optical communication apparatus 2 and the additional free-space optical communication apparatus are each the other end of communication of the free-space optical communication apparatus 1. However, the free-space optical communication apparatus 2 and the additional free-space optical communication apparatus can be configured the same as the free-space optical communication apparatus 1.

### <Configuration of Free-Space Optical Communication Apparatus 1>

The free-space optical communication apparatus 1 in accordance with the present example embodiment is a communication apparatus for conducting free-space optical communication. Free-space optical communication is the communication conducted with use of light propagating through space. Examples of the light used in the free-space optical communication can include a millimeter wave, a submillimeter wave, infrared light, visible light, and ultraviolet light.

The free-space optical communication apparatus 1 includes a light sending and receiving section 10, and a communication control section 11, as illustrated in FIG. 1. The light sending and receiving section 10 is an example implementation of the light sending and receiving means recited in the claims, and the communication control section 11 is an example implementation of the communication control means recited in the claims.

### (Light Sending and Receiving Section 10)

The light sending and receiving section 10 sends and receives communication light. This means that the light sending and receiving section 10 includes a light sending section (light sending means) for sending communication light and a light receiving section (light receiving means) for receiving light. The communication light is light used for free-space optical communication, and is continuous light that has superimposed therein pieces of digital information (communication signals) each of which contains the content of communication. For example, the communication light is laser light. The light sending and receiving section 10 superimposes packets, each being digital information, in the communication light. Further, the light sending and receiving section 10 includes a light-emitting element in the light sending section thereof, and may include a lens or the like. The details of the configuration of the light sending and receiving section 10 will be described later.

The communication light sent from the light sending and receiving section 10 is received by the other end of the communication, specifically by a light sending and receiving section 20 of the free-space optical communication apparatus 2 or a light sending and receiving section of the additional free-space optical communication apparatus. Conversely, communication light sent from the other end of the communication, specifically from the light sending and receiving section 20 of the free-space optical communication apparatus 2 or the light sending and receiving section of the additional free-space optical communication apparatus is received by the light sending and receiving section 10 of the free-space optical communication apparatus 1.

### (Communication Control Section 11)

The communication control section 11 controls communication conducted via the light sending and receiving section 10. Specifically, the communication control section 11 causes the light sending and receiving section 10 to send either a first packet or first coded information, with respect to a plurality of packets received by the light sending and receiving section 10. The first packet is a given packet of the plurality of packets received by the light sending and receiving section 10. The first coded information is information which contains the first packet and which is generated by network coding performed by the communication control section 11. The first packet is sent from the light sending and receiving section of the additional free-space optical communication apparatus. Further, the first packet and the first coded information are sent to the light sending and receiving section 20 of the free-space optical communication apparatus 2.

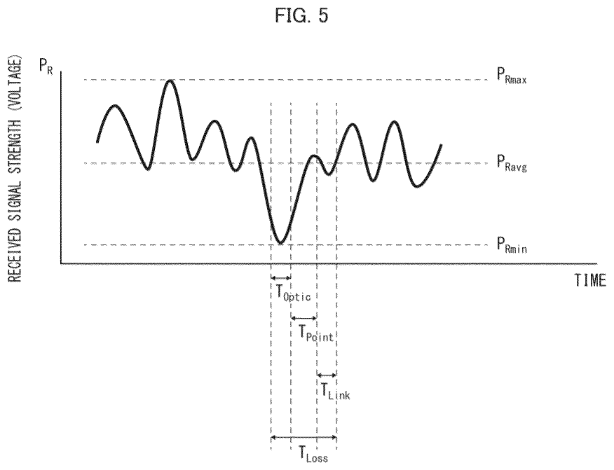

After either the first packet or the first coded information is sent, the communication control section 11 causes the light sending and receiving section 10 to send second coded information. The second coded information is information which contains the first packet and a second packet and which is generated by the network coding performed by the communication control section 11. The second packet is a packet received by the light sending and receiving section 10 at a point in time at which a first predetermined time T_{Loss} (see FIG. 5) elapses from a point in time at which either the first packet or the first coded information is sent. The second coded information is sent to the light sending and receiving section 20 of the free-space optical communication apparatus 2. The details of the first predetermined time T_{Loss} will be described later.

### <Example Advantage Produced by Free-Space Optical Communication System 100 and Free-Space Optical Communication Apparatus 1>

As above, a configuration adopted in the free-space optical communication apparatus 1 in accordance with the present example embodiment and the free-space optical communication system 100 including the free-space optical communication apparatus 1 is the configuration in which a light sending and receiving means for sending and receiving communication light and a communication control means for controlling communication conducted via the light sending and receiving means are included, and the communication control means causes the light sending and receiving means to send either a first packet or first coded information, with respect to a plurality of packets received by the light sending and receiving means, the first coded information containing the first packet and being generated by network coding, and then causes the light sending and receiving means to send second coded information which contains the first packet and a second packet, the second packet being received by the light sending and receiving means at a point in time at which a first predetermined time elapses from a point in time at which either the first packet or the first coded information is sent.

With this configuration, according to the present example embodiment, it is possible to restore a once-attenuated or once-lost packet by decoding the second coded information, even in a case where fading or the like occurs at the time of sending data from the light sending and receiving section 10. This makes it possible to effectively reduce the occurrence of burst errors caused by the attenuation or loss of packets. In addition, since the second coded information is obtained by subjecting network coding to the first packet, etc., it is possible to conduct packet communication without increasing the total communication data size even in a case where the amounts of information of packets and the number of packets increase, and avoid communication breakdown such as network delay. In light of the above, it can be said that the free-space optical communication apparatus 1 and the free-space optical communication system 100 including the free-space optical communication apparatus 1 are highly reliable free-space optical communication techniques.

### <Flow of Free-Space Optical Communication Method S1>

Here is a description of a flow of a free-space optical communication method S1 in accordance with the present example embodiment, provided with reference to FIG. 2. FIG. 2 is a flowchart illustrating a flow of the free-space optical communication method S1 carried out by the free-space optical communication system 100 in accordance with the present example embodiment.

The free-space optical communication method S1 includes a communication control step (step S10) of carrying out communication control via the light sending and receiving section 10, as illustrated in FIG. 2. This communication control step (S10) includes a first sending step (S11) of causing the light sending and receiving section 10 to send either the first packet or the first coded information with respect to the plurality of packets received by the light sending and receiving section 10. Further, the communication control step (S10) includes a second sending step (S12) of causing the light sending and receiving section 10 to send second coded information after the end of the first sending step (S11).

### <Example Advantage Produced by Free-Space Optical Communication Method S1>

As above, the free-space optical communication method S1 in accordance with the present example embodiment makes it possible to provide smooth free-space optical communication while effectively reducing the occurrence of burst errors caused by the attenuation or loss of packets. Thus, the free-space optical communication method S1 can be said to be a highly reliable free-space optical communication method.

### Second Example Embodiment

The following description will discuss a second example embodiment of the present invention in detail, with reference to the drawings. A component having the same function as a component described in the first example embodiment is assigned the same reference sign, and the description thereof is omitted where appropriate.

### <Configuration of Free-Space Optical Communication System 200>

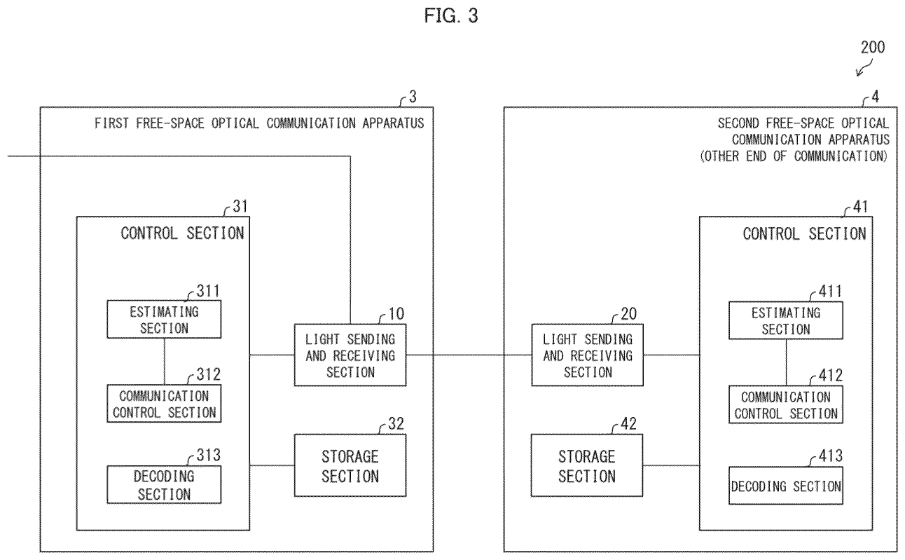

Here is a description of a configuration of a free-space optical communication system which includes a free-space optical communication apparatus in accordance with the present example embodiment, provided with reference to FIG. 3. FIG. 3 is a block diagram illustrating a configuration of a free-space optical communication system 200. The free-space optical communication system 200 includes: a first free-space optical communication apparatus 3, a second free-space optical communication apparatus 4, and an additional free-space optical communication apparatus (not illustrated), to provide spatial multiplexing transmission by simultaneous connection of multiple signals of communication light. The communication scheme of the free-space optical communication system 200 is packet communication, as in the free-space optical communication system 100. Although illustrated in FIG. 3 is an example in which the free-space optical communication system 200 includes the two free-space optical communication apparatuses, the number of free-space optical communication apparatuses included in the free-space optical communication system 200 is not limited to the example in FIG. 3.

In the following description, the first free-space optical communication apparatus 3 is a free-space optical communication apparatus of interest, and the second free-space optical communication apparatus 4 and the additional free-space optical communication apparatus are each the other end of communication of the free-space optical communication apparatus 3. Therefore, the additional free-space optical communication apparatus is a sender of a first packet sent to the first free-space optical communication apparatus 3. The second free-space optical communication apparatus 4 is a receiver of second coded information sent from the first free-space optical communication apparatus 3. In the example of FIG. 3, the first free-space optical communication apparatus 3, the second free-space optical communication apparatus 4, and the additional free-space optical communication apparatus have the same configuration.

### <Configuration of First Free-Space Optical Communication Apparatus 3>

The first free-space optical communication apparatus 3 in accordance with the present example embodiment includes a light sending and receiving section 10, a control section 31, and a storage section 32, as illustrated in FIG. 3. In the storage section 32, various types of data including predetermined parameters which indicate the states of light reception, such as a light reception level and a packet loss, are stored. In addition, a packet sent or received by the light sending and receiving section 10 and first coded information and second coded information generated by a communication control section 312 are stored in the storage section 32.

### (Light Sending and Receiving Section 10)

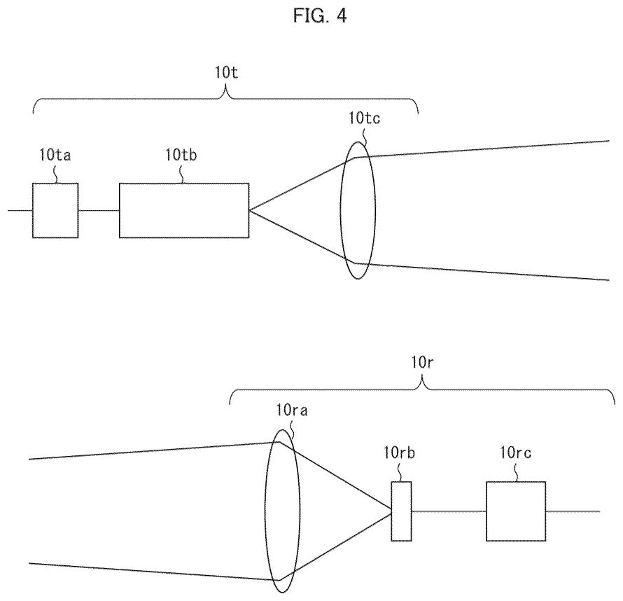

Since an optical communication medium to be sent and received by the light sending and receiving section 10, i.e., communication light, is described above, the description thereof in the present example embodiment is omitted. The light sending and receiving section 10 may be any well-known light sending and receiving section capable of being used for free-space optical communication. The description of the present example embodiment is provided by taking, as an example of the light sending and receiving section 10, a well-known light sending and receiving section having the configuration illustrated in FIG. 4.

Illustrated in the example of FIG. 4 is an example aspect in which a light sending section 10t for sending the optical communication medium and a light receiving section 10r for receiving the optical communication medium have different configurations. The light sending section 10t is configured to send, to the outside thereof through a collimator lens 10tc, laser light (optical communication medium) emitted from a laser light source 10tb in response to a signal from an electrical-optical converting section 10ta. The light receiving section 10r is configured to concentrate laser light coming from the outside with use of a lens 10ra, and then receive the concentrated light via a light receiving element 10rb, to convert the received light into an electrical signal via an electrical-optical concerting section 10rc.

### (Control Section 31)

The control section 31 controls the sections of the first free-space optical communication apparatus 3 as a whole. Here is a description of a detailed configuration of the control section 31. The control section 31 includes an estimating section 311, a communication control section 312, and a decoding section 313. Since the decoding section 313 has the same configuration and function as a decoding section 413 (described later) of the second free-space optical communication apparatus 4, the description thereof is omitted.

### (Estimating Section 311)

The estimating section 311 estimates a duration time of fading which occurs during packet communication, by measuring the signal strengths of a plurality of packets received by the light sending and receiving section 10. The estimating section 311 is an example implementation of the estimating means recited in the claims. Fading is a phenomenon in which the reception level of a radio wave fluctuates in the course of wireless communication, which includes free-space optical communication. Fading is one of the main causes of a burst error in free-space optical communication.

The following description is provided by taking fading as an example of a burst error which occurs in the free-space optical communication system 200. However, the free-space optical communication system 200 produces an example advantage not only in a case of fading but also in burst errors in general. In addition, the duration time of fading estimated by the estimating section 311 is referred to as an “estimated duration time T_{Optic}”.

The description of the present example embodiment is provided by taking the example illustrated in FIG. 5 as an example of the estimating process carried out by the estimating section 311. First, the estimating section 311 measures the signal strength (hereinafter, “received signal strength”) of each of the plurality of packets received by the light sending and receiving section 10 within a predetermined period of time, to determine changes in received signal strength over time as illustrated in FIG. 5.

The predetermined period of time above can be set to any period of time provided that the period of time is so long that the changes in received signal strength over time which represent occurrence of fading can be contained. In other words, the number of packets required for the estimating section 311 to determine the changes in received signal strength over time is in no way limited provided that the number makes it possible to specify the changes in received signal strength over time which represent occurrence of fading.

Next, from the changes in received signal strength over time, the estimating section 311 specifies the point in time at which the received signal strength is the lowest. The estimating section 311 then designates a certain interval of time which spans from before to after the point in time at which the received signal strength is the lowest, and use the certain interval of time and the lowest value of the received signal strength as parameters to perform a fast Fourier transform (FFT). Through this FFT, the estimating section 311 calculates a frequency corresponding to the maximum amplitude of the received signal strength in the above-described interval. Lastly, the estimating section 311 uses “1/calculated frequency” as the estimated duration time T_{Optic}.

In the present example embodiment, before the free-space optical communication system 200 conducts packet communication (hereinafter, shortened into “before the start of packet communication”), the estimating section 311 calculates the estimated duration time T_{Optic} in advance. The estimating section 311 then sends the calculated estimated duration time T_{Optic} to the communication control section 312.

The first free-space optical communication apparatus 3 can acquire the estimated duration time T_{Optic} by a method other than the method used in a case where the estimating section 311 carries out the estimating process as is carried out in the present example embodiment. For example, the first free-space optical communication apparatus 3 may acquire the estimated duration time T_{Optic} by the light sending and receiving section 10 receiving an estimated duration time T_{Optic} calculated by an estimating section 411 of the second free-space optical communication apparatus 4.

In a case where the first free-space optical communication apparatus 3 acquires the estimated duration time T_{Optic} from the estimating section 411, the estimating section 411 may calculate the estimated duration time T_{Optic} by carrying out the estimating process as is carried out in the present example embodiment.

Alternatively, after measuring a plurality of real duration times each of which is the duration time of fading that actually occurs during packet communication, the estimating section 411 may use the maximum value of the plurality of real duration times as the estimated duration time T_{Optic}. In this case, the estimating section 411 specifies the plurality of real duration times by measuring the signal strengths of a plurality of packets received by the light sending and receiving section 20 of the second free-space optical communication apparatus 4 within a predetermined period of time. However, the estimating section 411 may use the average of the plurality of real duration times as the estimated duration time T_{Optic}, instead of the above-described maximum value. Further, a few percent of the plurality of real duration times may be extracted in the descending order of numerical value, to use the average value of the extracted real duration times as the estimated duration time T_{Optic}. Furthermore, the estimating section 311 may calculate the estimated duration time T_{Optic} based on the measurement of the plurality of real duration times. A series of these processes is preferably carried out in advance, before the start of packet communication.

### (Communication Control Section 312)

The communication control section 312 has a function equivalent to that of the communication control section 11 described in the first example embodiment, and is an example implementation of the communication control means recited in the claims. In the present example embodiment, the communication control section 312 has the function of setting a first predetermined time T_{Loss} with use of the estimated duration time T_{Optic} received from the estimating section 311, in addition to a function equivalent to that of the communication control section 11.

Specifically, the communication control section 312 sets the first predetermined time T_{Loss} to the sum of the estimated duration time T_{Optic} and at least one selected from the group consisting of an adjustment time T_{Point} and a synchronization time T_{Link}. The adjustment time T_{Point} is a time required to adjust again the angle of an antenna (not illustrated) of the light sending and receiving section 10, in order for further occurrence of fading to be reduced. The synchronization time T_{Link} is a time required for synchronizing (specifically, clock synchronization) again a communication signal of packet communication conducted by the free-space optical communication system 200 for linkup. More specifically, the synchronization time T_{Link} is a delay time which is a time from when the clock synchronization of a communication signal of the packet communication conducted by the free-space optical communication system 200 enters the state of being lost to when the clock synchronization is brought about again in response to the input of a signal. The synchronization time T_{Link} varies from free-space optical communication apparatus to free-space optical communication apparatus, and an observed value of which is, for example, 1 (ms).

In the present example embodiment, the communication control section 312 calculates the first predetermined time T_{Loss} by adding both the adjustment time T_{Point} and the synchronization time T_{Link} to the estimated duration time T_{Optic}, as illustrated in FIG. 5. In the example of FIG. 5, the communication control section 312 calculates the adjustment time T_{Point} by Formula (1) below. However, another formula may be used for the calculation.

$${T}_{Point} = S ( L ) = 0.01 + 0.0 \; 001 \times L \qquad Formula ( 1 )$$

S (L): the function indicating the degree of misalignment, corresponding to communication distance, of the axis of the antenna, L: communication distance

Further, in the present example embodiment, the adjustment time T_{Point} and the synchronization time T_{Link} which are calculated in advance, before the start of packet communication are temporarily stored in the storage section 32. The communication control section 312 then retrieves the adjustment time T_{Point} and the synchronization time T_{Link} from the storage section 32 at the time of calculation of the first predetermined time T_{Loss}.

Note that the communication control section 312 may set the adjustment time T_{Point} and the synchronization time T_{Link}, according to whether the estimated duration time T_{Optic} is long or short, or how the changes in received signal strength over time are. Further, the communication control section 312 may use, as the first predetermined time T_{Loss}, the sum of the adjustment time T_{Point} and the estimated duration time T_{Optic}, or may use, as the first predetermined time T_{Loss}, the sum of the synchronization time T_{Link} and the estimated duration time T_{Optic}. Further, the communication control section 312 may set the first predetermined time T_{Loss} to the estimated duration time T_{Optic} as it is, without using both the adjustment time T_{Point} and the synchronization time T_{Link}.

Optionally, the communication control section 312 does not use any of the adjustment time T_{Point}, the synchronization time T_{Link}, and the estimated duration time T_{Optic}, at the time of setting the first predetermined time T_{Loss}. This case eliminates the need for the estimating section 311, and the first predetermined time T_{Loss} can be set to any value which falls within the range that allows a reduction in occurrence of burst errors. In addition, the first predetermined time T_{Loss} of this case may be stored in the storage section 32 in advance, or may be inputted by a user via an operation input section (not illustrated) included in the first free-space optical communication apparatus 3.

Although carried out before the start of packet communication in the present example embodiment, the calculation of the estimated duration time T_{Optic} and the setting of the first predetermined time T_{Loss} may be carried out after the start of the packet communication. In this case, the communication control section 312 may transfer, to the second free-space optical communication apparatus 4, the packet as received by the light sending and receiving section 10, until the first predetermined time T_{Loss} is set. After the first predetermined time T_{Loss} is set, the communication control section 312 may carry out a coded information sending process, which will be described later.

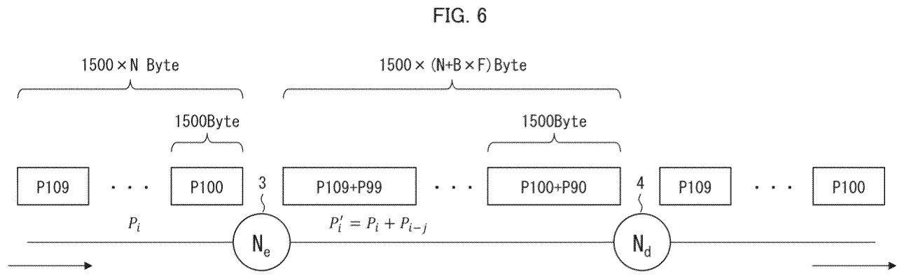

The communication control section 312 sets the first predetermined time T_{Loss}, and then carries out the coded information sending process. Here is a description of the principle of the coded information sending process, provided by taking FIG. 6 for example, The communication control section 312 performs, on packets received by the light sending and receiving section 10, the coded information sending process on a per-round basis. In the example of FIG. 6, 10 packets are contained per round. That is, the value of “N” in FIG. 6 is 10. Illustrated in FIG. 6 is an example in which one specific round contains 10 packets which are packets P100 to P109. Further, in the example of FIG. 6, since the amount of information of each packet is 1500 (byte), the amount of information per round is 1500×N (N=10).

Specifically, the communication control section 312 causes the light sending and receiving section 10 to send a given packet Pᵢ₋ⱼ (first packet) as it is, the given packet Pᵢ₋ⱼ being contained in the one specific round. In addition, the communication control section 312 stores the given packet Pᵢ₋ⱼ in the storage section 32.

After causing the light sending and receiving section 10 to send the given packet Pᵢ₋ⱼ, the communication control section 312 retrieves the given packet Pᵢ₋ⱼ from the storage section 32. The communication control section 312 then performs network coding on the given packet Pᵢ₋ⱼ and a packet Pᵢ (second packet), to generate second coded information Pᵢ′ (=Pᵢ+Pᵢ₋ⱼ). The packet Pᵢ is a packet received by the light sending and receiving section 10 at a point in time at which the first predetermined time T_{Loss} elapses from the point in time at which the given packet Pᵢ₋ⱼ is sent. The communication control section 312 then causes the light sending and receiving section 10 to send the second coded information Pᵢ′ generated. The communication control section 312 repeatedly carries out the above series of processes, which is the coded information sending process.

In the example of FIG. 6, given that a packet transfer rate is B and the first predetermined time T_{Loss} is F, the amount, per round, of the second coded information Pᵢ′ sent by the light sending and receiving section 10 to the second free-space optical communication apparatus 4 is 1500×(N+B×F) (Byte). For example, given that the packet transfer rate is 83,333 (pkt/s) and the first predetermined time T_{Loss} is 2 (ms), the amount of the second coded information Pᵢ′ per round is 1500×(10+83,333×0.002)≈2,514 (KByte).

Here is a description of a process of generating the second coded information Pᵢ′ described above, with the process being applied to the one specific round illustrated in FIG. 6. Assume that at a point in time at which the first predetermined time T_{Loss} elapses from the point in time at which the one specific round is sent, packets received by the light sending and receiving section 10 in a round contains 10 packets which are packets P90 to P99.

For example, in a case where the given packet Pᵢ₋ⱼ is the “packet P90”, the packet Pᵢ is a “packet P100”, and the second coded information Pᵢ′ is “packet P100+packet P90”. In this expression, the symbol “+” represents the network coding. As another example, in a case where the given packet Pᵢ₋ⱼ is the “packet P99”, the packet Pᵢ is a “packet P109”, and the second coded information Pᵢ′ is “packet P109+packet P99”.

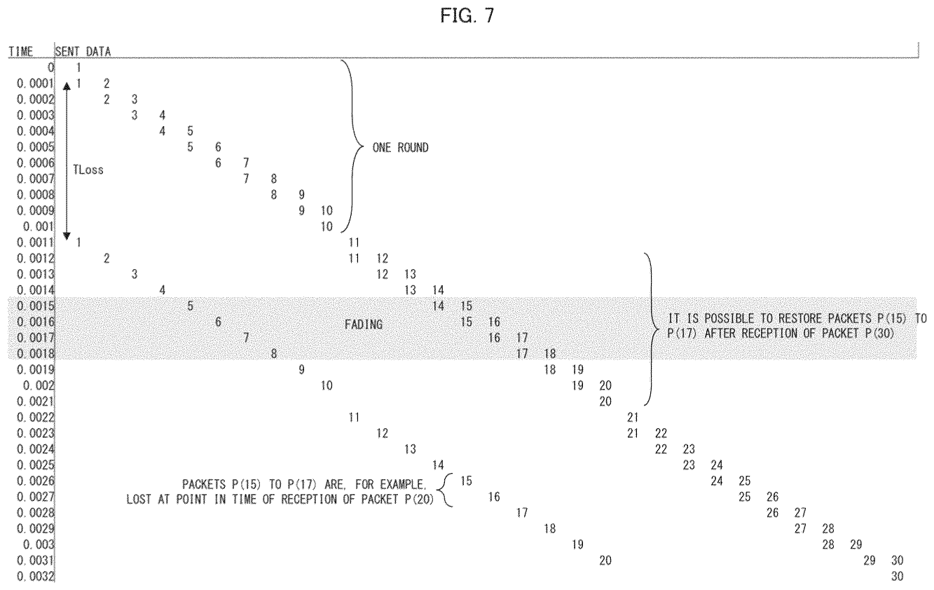

The communication control section 312 may cause the light sending and receiving section 10 to send the first coded information instead of the given packet Pᵢ₋ⱼ at the time at which the light sending and receiving section 10 receives one specific packet, although such a case is not illustrated. In this case, the communication control section 312 performs network coding on a given packet Pᵢ and a packet (see FIG. 7) immediately preceding the given packet Pᵢ, to generate the first coded information. The communication control section 312 then causes the light sending and receiving section 10 to send the first coded information generated. In addition, the communication control section 312 stores the first coded information in the storage section 32.

After causing the light sending and receiving section 10 to send the first coded information, the communication control section 312 retrieves the first coded information from the storage section 32. The communication control section 312 then performs network coding on the first coded information and the packet Pᵢ, to generate the second coded information Pᵢ′. The communication control section 312 then causes the light sending and receiving section 10 to send the second coded information Pᵢ′ generated.

On the basis of FIG. 7, a specific example of the coded information sending process carried out by the communication control section 312 will be described next. The numbers “1” to “28” in FIG. 7 are numbers assigned to packets, and represent the order in which the light sending and receiving section 10 receives the packets.

In the following description, a packet received nth by the light sending and receiving section 10 is denoted by a “packet P (n)”. For example, the packet received first (1st) by the light sending and receiving section 10 is denoted by a “packet P(1)”. In addition, the first coded information and the second coded information generated when the light sending and receiving section 10 receives the packet P(n) are denoted respectively by “first coded information P((n−1)+n)” and “second coded information P′ ((n-m)+n)” or “second coded information P′ ((n-m)+(n−1)+n”. The symbol “m” is the number of pieces of data sent per round.

In the following description, assume that the sending time of the packet P(1) is “0”, and thereafter, the light sending and receiving section 10 carries out sending and receiving at intervals of 0.0001 (s). Assume also that the communication control section 312 sets the first predetermined time T_{Loss} to 0.001 (s).

In the specific example of FIG. 7, at the point in time at which the light sending and receiving section 10 receives the packet P(1), it is uncertain whether there is a subsequent packet, and the communication control section 312 therefore causes the light sending and receiving section 10 to send the packet P(1) as it is. This makes it possible to avoid the communication control section 312 bringing about an unnecessary wait for the packet P(1) to be sent in order to generate the first coded information despite the absent of a subsequent packet. Further, in a case where there is a subsequent packet, the communication control section 312 can immediately generate the first coded information with use of the packet P(1). It is therefore possible to smoothly send packets to the second free-space optical communication apparatus 4, regardless of the presence or absence of a subsequent packet.

It should be noted that it is not necessary for the communication control section 312 to cause the light sending and receiving section 10 to send the packet P(1) as it is. For example, upon reception of a subsequent packet while causing the light sending and receiving section 10 to wait to send the packet P(1), the communication control section 312 may cause the light sending and receiving section 10 to send the first coded information obtained by performing network coding on the packet P(1) and the subsequent packet.

When the light sending and receiving section 10 receives a packet P(2) after sending the packet P(1), the communication control section 312 performs network coding on the packet P(1) and the packet P(2) to generate the first coded information P(1+2). The communication control section 312 then causes the light sending and receiving section 10 to send the first coded information P(1+2) generated. Thereafter, the communication control section 312 repeats a series of these processes until causing the light sending and receiving section 10 to send the first coded information P(9+10).

It is not necessary for the communication control section 312 to cause the light sending and receiving section 10 to send the first coded information P(1+2) to P(9+10). For example, the communication control section 312 may cause the light sending and receiving section 10 to send all the packets P(1) to P(10) as they are, without generating the first coded information P(1+2) to P(9+10). However, the possibility of making it possible to decode the packets P(1) to P(10) in a case of occurrence of fading is higher in a case of generating the first coded information P(1+2) to P(9+10), as in the specific example of FIG. 7, than in a case of not generating the first coded information P(1+2) to P(9+10). It is therefore preferable that the first coded information P(1+2) to P(9+10) be generated by the communication control section 312.

After the first coded information P(9+10) is sent, the communication control section 312 retrieves the packet P(10) from the storage section 32 again, and causes the light sending and receiving section 10 to send the packet P(10) as it is. A series of packet communications up to this packet sending constitutes one round.

As is described above, it is not necessary to send, in the last sending occasion of one round, one packet sent in the sending occasion immediately prior to the last sending occasion, as it is, and the process of sending the packet may be omitted. However, the possibility of making it possible to decode the one packet in a case of occurrence of fading is higher in a case of sending the one packet as it is in the last sending occasion of one round than in a case of not sending the one packet. In addition, because this sending process is carried out only once, in the last sending occasion of one round, smooth sending of packets to the second free-space optical communication apparatus 4 does not suffer. It is therefore preferable to send the one packet as it is in the last sending occasion of one round.

At the point in time at which the light sending and receiving section 10 receives a packet P(11) after the packet P(10) is sent, the first predetermined time T_{Loss} is supposed to elapse. The communication control section 312 retrieves again the packet P(1) from the storage section 32 and performs network coding on the packet P(1) and the packet P(11), to generate the second coded information P′ (1+11). The communication control section 312 then causes the light sending and receiving section 10 to send the second coded information P′(1+11) generated. At the point in time at which the light sending and receiving section 10 sends the second coded information P′(1+11), the next one round starts.

When the light sending and receiving section 10 receives a packet P(12) after sending the second coded information P′ (1+11), the communication control section 312 retrieves the packet P(11) and retrieves again the packet P(2), from the storage section 32. The communication control section 312 then performs network coding on the packet P(2), the packet P(11), and the packet P(12), to generate the second coded information P′ (2+11+12). The communication control section 312 then causes the light sending and receiving section 10 to send the second coded information P′(2+11+12) generated. Thereafter, the communication control section 312 repeats a series of these processes until causing the light sending and receiving section 10 to send the second coded information P′ (10+19+20).

After the second coded information P′ (10+19+20) is sent, the communication control section 312 retrieves again the packet P(20) from the storage section 32 and causes the light sending and receiving section 10 to send the packet P(20) as it is. At the point in time at which the light sending and receiving section 10 sends the packet P(20), the next one round ends.

After the light sending and receiving section 10 receives a packet P(21), processes the same as the series of processes which are from the light sending and receiving section 10 receiving the packet P(11) to the light sending and receiving section 10 sending the packet P(20) as it is are repeated.

The above series of processes translates into the following: the communication control section 312 of the first free-space optical communication apparatus 3 causes the light sending and receiving section 10 to send an unprocessed packet, the first coded information, and the second coded information. The unprocessed packet is a packet which has not undergone network coding performed by the communication control section 312. In the example of FIG. 7, the unprocessed packets are: the packet P(1) at time 0 (s); the packet P(10) at time 0.001 (s); the packet P(20) at time 0.0021 (s); and a packet P(30) at time 0.0032 (s). Thus, the first free-space optical communication apparatus 3 is an example implementation of another free-space optical communication apparatus recited in the claims.

As illustrated in FIG. 7, in a case of occurrence of fading in the period from time 0.0015 (s) to time 0.0018 (s), packets P(15) to P(17) are, for example, lost at the point in time at which the light sending and receiving section 10 receives the packet P(20). However, the communication control section 312 will generate the second coded information P′(15+24+25) to P′ (17+26+27) at a later time. Therefore, by the decoding section 413 (described later) decoding these pieces of second coded information, it is possible to restore information carried on each of the packets P(15) to P (17).

### <Configuration of Second Free-Space Optical Communication Apparatus 4>

The second free-space optical communication apparatus 4 in accordance with the present example embodiment includes a light sending and receiving section 20, a control section 41, and a storage section 42, as illustrated in FIG. 3. Since an optical communication medium to be sent and received by the light sending and receiving section 20, i.e., communication light, is described above, the description thereof in the present example embodiment is omitted. Like the light sending and receiving section 10, the light sending and receiving section 20 may be a well-known light sending and receiving section having the configuration illustrated in FIG. 4.

The control section 41 has the same configuration as the control section 31 of the first free-space optical communication apparatus 3. The control section 41 includes an estimating section 411, a communication control section 412, and a decoding section 413. Since the estimating section 411 is described above in detail, the description thereof is omitted here. The communication control section 412 has the same configuration as the communication control section 312 of the first free-space optical communication apparatus 3. Thus, the communication control section 412 is an example implementation of the communication control means recited in the claims.

### (Decoding Section 413)

The decoding section 413 is a section capable of decoding the unprocessed packet, the first coded information, and the second coded information. Further, according to the present example embodiment, the decoding section 413 decodes the unprocessed packet, the first coded information, and the second coded information which are sent by the light sending and receiving section 10 of the first free-space optical communication apparatus 3. Thus, the decoding section 413 is an example implementation of the decoding means recited in the claims.

In the example of FIG. 6, in a case where, for example, the light sending and receiving section 20 receives “packet P100+packet P90” as the second coded information Pᵢ′, the decoding section 413 has already decoded the packet P90 unless fading or the like has occurred. Thus, the decoding section 413 decodes the “packet P100+packet P90” to restore the information carried on the packet P100. As another example, in a case where the light sending and receiving section 20 receives “packet P109+packet P99” as the second coded information Pᵢ′, the decoding section 413 has already decoded the packet P99 unless fading or the like has occurred. Thus, the decoding section 413 decodes the “packet P109+packet P99” to restore the information carried on the packet P109.

In the example of FIG. 7, the decoding section 413 decodes the first coded information P((n−1)+n) to restore the information carried on the packet P(n), in one round for the packets P(1) to P(10). Next, after one round for the second coded information P′ (1+11) to the packet P(20), the decoding section 413 decodes the second coded information P′ ((n−m)+n) or P′ ((n−m)+(n−1)+n) to restore the information carried on the packet P (n).

The decoding section 413 decodes the second coded information P′(15+24+25) to P′(17+26+27) in one round for the second coded information P′(11+21) to a packet P(30). Thus, even in a case of occurrence of fading in a period from time 0.0015 (s) to 0.0018 (s), it is possible for the decoding section 413 to restore the information carried on the packets P(15) to P(17) which are, for example, lost in the previous one round.

### <Example Advantage Produced by Free-Space Optical Communication System 200 and Each of Free-Space Optical Communication Apparatuses 3 and 4>

A configuration adopted in the free-space optical communication apparatuses (first free-space optical communication apparatus 3 and second free-space optical communication apparatus 4) in accordance with the present example embodiment and the free-space optical communication system 200 including these free-space optical communication apparatuses is the configuration in which an estimating means for estimating the duration time of fading which occurs during packet communication by measuring the signal strengths of a plurality of packets received by the light sending and receiving means is further included, and the communication control means sets the first predetermined time to an estimated duration time which is the duration time of fading estimated by the estimating means.

It is therefore possible to reduce the occurrence of a situation where the total communication data size increases to a greater degree than required, because of too early a timing of generation of the second coded information. It is also possible to reduce the occurrence of a situation where it is impossible to restore an attenuated or lost packet because of too late a timing of generation of the second coded information. This makes it possible to efficiently generate the second coded information, and thus provide smoother free-space optical communication.

Further, a configuration adopted in the free-space optical communication apparatuses and the free-space optical communication system 200 in accordance with the present example embodiment is the configuration in which an estimating means for estimating the duration time of fading which occurs during packet communication by measuring the signal strengths of a plurality of packets received by the light sending and receiving means is further included, and the communication control means sets the first predetermined time to the sum of an estimated duration time estimated by the estimating means and at least one selected from the group consisting of an adjustment time and a synchronization time, the adjustment time being required for adjustment of an angle of an antenna of the light sending and receiving section, the synchronization time being required for synchronization of a communication signal of the packet communication.

As above, according to the present example embodiment, at least one selected from the group consisting of the adjustment time and the synchronization time is taken into consideration at the time of setting the first predetermined time. This makes it possible to generate the second coded information at a more appropriate timing than in the case where these times are not taken into consideration. It is therefore possible to more efficiently generate the second coded information, and thus provide smoother free-space optical communication.

Further, a configuration adopted in the free-space optical communication apparatuses and the free-space optical communication system 200 in accordance with the present example embodiment is the configuration in which at least two of the free-space optical communication apparatuses each further include a decoding means capable of decoding an unprocessed packet, the first coded information, and the second coded information, the unprocessed packet being a packet not having undergone network coding performed by the communication control means, and the decoding means of one free-space optical communication apparatus of the at least two free-space optical communication apparatuses decodes the unprocessed packet, the first coded information, and the second coded information which are sent by the light sending and receiving means of another free-space optical communication apparatus of the at least two free-space optical communication apparatuses.

In light of the above, according to the present example embodiment, the decoding means of one free-space optical communication apparatus decodes all types of information which are sent by another free-space optical communication apparatus. This eliminates the omission of decoding, and thus makes it possible to reliably restore a packet which has once attenuated or once been lost due to fading or the like. It is therefore possible to increase the reliability of free-space optical communication to a greater degree, by more effectively reducing the occurrence of burst errors.

### <Flow of Free-Space Optical Communication Method S2>

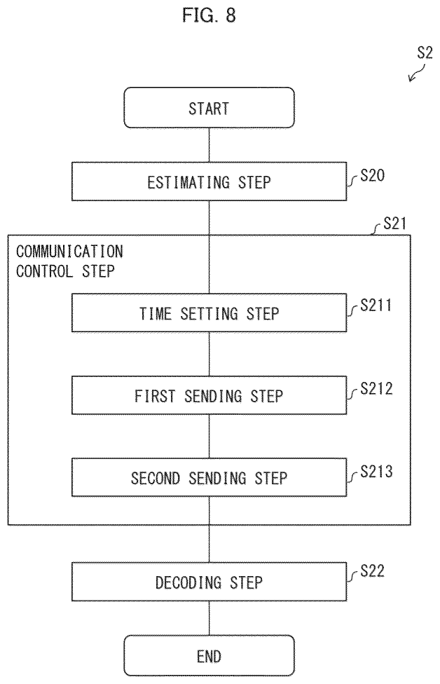

Here is a description of a flow of a free-space optical communication method S2 in accordance with the present example embodiment, provided with reference to FIG. 8. FIG. 8 is a flowchart illustrating a flow of the free-space optical communication method S1 carried out by the free-space optical communication system 200 in accordance with the present example embodiment.

The free-space optical communication method S2 includes an estimating step (S20), a communication control step (S21), and a decoding step (S22), as illustrated in FIG. 8. S20 is a step of estimating a duration time of fading which occurs during packet communication, by measuring the signal strengths of a plurality of packets. S21 is a step of performing control of packet communication conducted via the light sending and receiving means. S22 is a step of decoding the unprocessed packet, the first coded information, and the second coded information which are received by the light sending and receiving means.

In addition, the communication control step (S21) includes a time setting step (S211), a first sending step (S212), and a second sending step (S213). S211 is a step of setting the first predetermined time. S212 is a step of carrying out a process similar to step S111 illustrated in FIG. 2. S213 is a step of carrying out a process similar to step S112 illustrated in FIG. 2.

### (S20)

In S20, the estimating section 311 of the control section 31 estimates the duration time of fading which occurs during packet communication, to acquire an estimated duration time T_{Optic}. Since this acquisition is described above in detail, the description thereof is omitted.

### (S211)

In S211, the communication control section 312 of the control section 31 sets the first predetermined time T_{Loss} by adding the adjustment time T_{Point} and the synchronization time T_{Link} to the estimated duration time T_{Optic}. Since this setting is described above in detail, the details thereof is omitted.

### (S212)

In S212, the communication control section 312 of the control section 31 causes the light sending and receiving section 10 to send an unprocessed packet (e.g., the “packet P(1)” in FIG. 7) as it is. Thereafter, the communication control section 312 of the control section 31 causes the light sending and receiving section 10 to send the first coded information (e.g., the “first coded information P((n−1)+n) in FIG. 7). Since these sending processes are described above in detail, the descriptions thereof are omitted.

### (S213)

In S213, the communication control section 312 of the control section 31 causes the light sending and receiving section 10 to send the second coded information (e.g., the “second coded information Pᵢ′” in FIG. 6) at a point in time at which the first predetermined time T_{Loss} elapses from a point in time at which the light sending and receiving section 10 sends the first coded information. Since this sending process is described above in detail, the description thereof is omitted.

### (S22)

In S22, the decoding section 413 of the control section 41 decodes the unprocessed packet received by the light sending and receiving section 20. After decoding the unprocessed packet, the decoding section 413 of the control section 41 decodes the first coded information received by the light sending and receiving section 20. After decoding the first coded information, the decoding section 413 of the control section 41 decodes the second coded information received by the light sending and receiving section 20. Since this decoding process is described above in detail, the description thereof is omitted.

### (Variation)

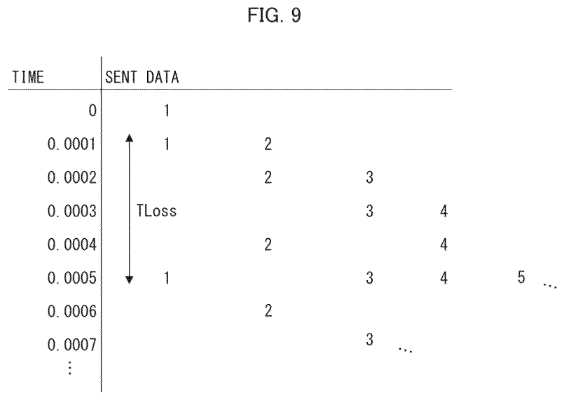

In the coded information sending process, the communication control section (communication control sections 312 and 412) of the free-space optical communication apparatuses in accordance with the present example embodiment may increase the data length of data which the communication control section causes the light sending and receiving section 10 to send. This will be described below, by taking FIG. 9 for example. Assume that the first predetermined time T_{Loss} is 0.0004 (s) in the example of FIG. 9. Assume also that the light sending and receiving section 10 sends packets P(1) to P(4) in the first one round.

In accordance with the specific example of FIG. 7, the communication control section 312 causes the light sending and receiving section 10 to send the packet P(4) as it is as of time 0.0004 (s). In contrast, the communication control section 312 in accordance with the present variation retrieves not only the packet P(4) but also the packet P(2) from the storage section 32 as of time 0.0004 (s). The communication control section 312 in accordance with the present variation performs network coding on the packet P(2) and the packet P(4) to generate the first coded information P(2+4), and then causes the light sending and receiving section 10 to send the first coded information. With this configuration, the data length, as of time 0.0004 (s), of the data sent by the light sending and receiving section 10 increases by the length of the packet P(2).

Further, in accordance with the specific example of FIG. 7, the communication control section 312 causes the light sending and receiving section 10 to send the second coded information P′(1+5) as of time 0.0005 (s). In contrast, the communication control section 312 in accordance with the present variation retrieves not only the packet P(1) but also the packets P(3) and P(4) from the storage section 32 as of time 0.0005 (s). The communication control section 312 in accordance with the present variation then performs network coding on the packet P(1), the packet P(3), the packet P(4), and the packet P(5) to generate the second coded information P′ (1+3+4+5), and causes the light sending and receiving section 10 to send the second coded information. With this configuration, the data length, as of the time 0.0005 (s), of data sent by the light sending and receiving section 10 increases by the lengths of the packets P(3) and P(4).

Increasing the degree of redundancy of data sent by the light sending and receiving section 10 as described above further increases the number of times the information carried on a lost packet or the like is successfully restored. It is therefore possible to more effectively address packet loss or the like caused by the occurrence of fading.

### Third Example Embodiment

The precondition of the first and second example embodiments described above is that a light sending and receiving section 10 reliably carries out the sending processes. However, this precondition is not essential, and a communication control section 312 may be configured to be capable of addressing a case where the light sending and receiving section 10 does not carry out a sending process at a certain timing due to some cause.

For example, in a case of a failure to send particular information from the light sending and receiving section 10, the communication control section 312 may cause the light sending and receiving section 10 to send the particular information after a second predetermined time elapses from a point in time at which the particular information becomes unsent. The particular information is information which has not been sent from the light sending and receiving section 10, and is either (i) a first packet or first coded information or (ii) second coded information. The point in time at which the particular information becomes unsent is a point in time at which the particular information should be originally sent. The second predetermined time is a time which can be set to any time, and may be stored in the storage section 32 in advance, or may be inputted by a user via an operation input section of a first free-space optical communication apparatus 3.

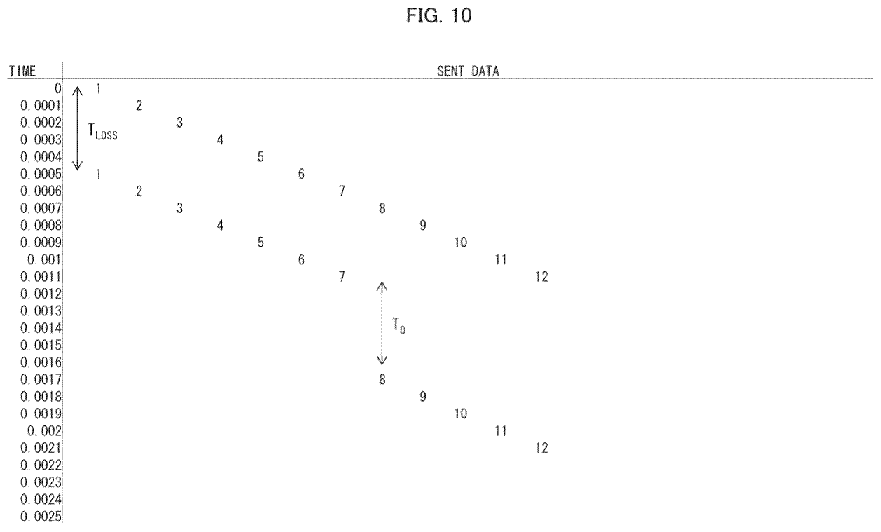

Here is a description of a distinctive process carried out by the communication control section 312 in accordance with the present example embodiment (shortened into “communication control section 312”), provided by taking FIG. 10 for example. In the example of FIG. 10, the communication control section 312 does not generate the first coded information, but instead causes the light sending and receiving section 10 to send the first packet as it is. Further, assume that a first predetermined time T_{Loss} is 0.0005 (s). Assume also that a second predetermined time Tₒ is set to 0.0005 (s) in advance, and stored in a storage section 32.

The precondition is that the communication control section 312 sets forced-sending times with respect to all pieces of data to be sent from the light sending and receiving section 10. The forced-sending time is a time to send, in a case of a failure to send data subjected to sending from the light sending and receiving section 10, the data subjected to sending, after the failure. Specifically, the forced-sending time is a time obtained by adding the second predetermined time Tₒ to the time at which the data subjected to sending should be originally sent.

For example, in a case where a packet P(1) is not contained in the second coded information P′ (1+6) sent at a point in time at which the time reaches 0.0005 (s), the communication control section 312 retrieves the packet P(1) from the storage section 32 at a point in time at which the time reaches 0.0005+Tₒ=0.001 (s). The communication control section 312 then causes the light sending and receiving section 10 to send the packet P(1). In this case, the packet P(1) is the particular information, and the forced-sending time is 0.001 (s).

In the example of FIG. 10, packets P(8) to P(12) to be sequentially sent at respective points in time at which the time reaches 0.0012 (s) to 0.0016 (s) are unsent. That is, the packets P(8) to P(12) are each the particular information. Thus, the communication control section 312 retrieves the packet P(8) from the storage section 32 at a point in time at which, for example, the time reaches 0.0012+Tₒ=0.0017 (s). The communication control section 312 then causes the light sending and receiving section 10 to send the packet P(8). Thereafter, at respective points in time at which the time reaches 0.0018 (s) to 0.0021 (s), the packets P(9) to P(12) are sequentially sent. That is, 0.0017 (s) to 0.0021 (s) are the forced-sending times. It should be noted that although each particular information is sent at a point in time at which the time reaches the corresponding forced-sending time in the example of FIG. 10, the particular information may be sent at any point in time after the time reaches the forced-sending time.

### <Flow of Distinctive Process Carried Out by Communication Control Section 312 of Present Example Embodiment>

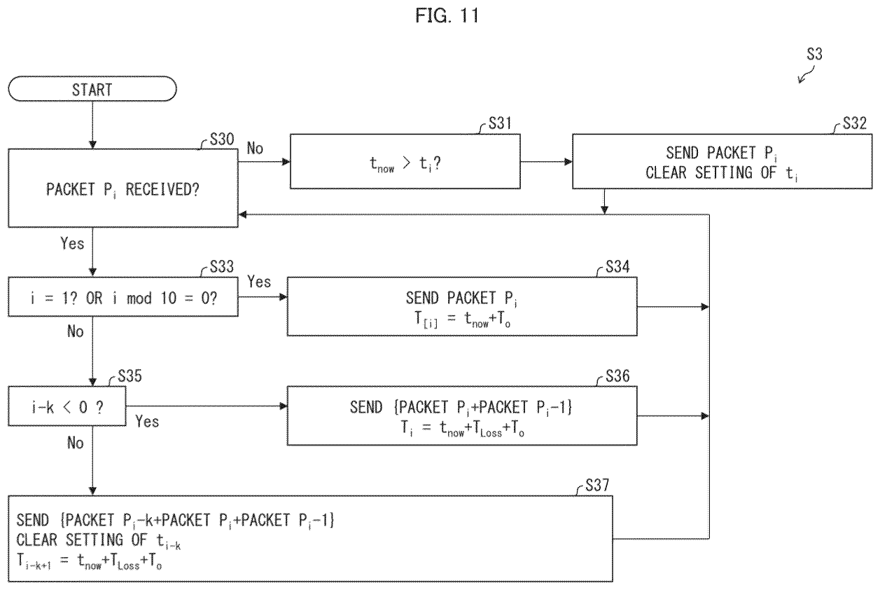

Here is a description of a flow of the above distinctive process S3 carried out by the communication control section 312, provided with reference to FIG. 11. FIG. 11 is a flowchart illustrating a flow of the distinctive process S3. The example of FIG. 11 is an example in which the communication control section 312 carries out a coded information sending process which is the specific example illustrated in FIG. 7.

### (S30)

In S30, the communication control section 312 judges whether the light sending and receiving section 10 has received a packet Pᵢ. In a case where the light sending and receiving section 10 has not received the packet Pᵢ (No in S30), the communication control section 312 proceeds to the process of S31. Conversely, in a case where the light sending and receiving section 10 has received the packet Pᵢ (Yes in S30), the communication control section 312 proceeds to the process of S33.

### (S31)

In S31, the communication control section 312 judges whether time t_{now}, which is the time of judgment in S30, is after the forced-sending time ti of the packet Pᵢ. In a case where time t_{now} is not after the forced-sending time ti (No in S31), the communication control section 312 carries out the process of S30 again. Conversely, in a case where time t_{now} is after the forced-sending time ti (Yes in S31), the communication control section 312 proceeds to the process of S32.

### (S32)

In S32, the communication control section 312 retrieves the packet Pᵢ from the storage section 32, and causes the light sending and receiving section 10 to send the packet Pᵢ. In addition, the communication control section 312 clears the setting of the forced-sending time ti. After the end of the process of S32, the communication control section 312 carries out the process of S30 again.

### (S33)

In S33, the communication control section 312 judges whether a reception ordinal number i of a packet Px is “1”, or whether the reception ordinal number i satisfies “i mod 10=0”. In a case where the reception ordinal number i satisfies either one of these two conditions (Yes in S33), the communication control section 312 proceeds to the process of S34. Conversely, in a case where the reception ordinal number i does not satisfy either of these two conditions (No in S33), the communication control section 312 proceeds to the process of S35.

### (S34)

In S34, the communication control section 312 causes the light sending and receiving section 10 to send the packet Pᵢ as it is. This makes it possible to prevent a period until information carried on a lost packet or the like is restored by a decoding section 413 from being too long, and thus provide reliable and smooth free-space optical communication. Further, the communication control section 312 allows for a situation where the packet Pᵢ is not contained in the second coded information which is to be sent later, and sets the forced-sending time tᵢ. The forced-sending time tᵢ set in this case is a time obtained by adding, to the time t_{now} of judgment in S33, the second predetermined time Tₑ and the first predetermined time T_{Loss} which corresponds to the second coded information containing the packet Pᵢ. After the end of the process of S34, the communication control section 312 carries out the process of S30 again.

### (S35)

In S35, the communication control section 312 judges whether a condition “i−k<0” is satisfied. In this expression, “k” is the number of packets contained in one round. In the example of FIG. 11, k=11. In a case where the condition “i−k<0” is satisfied (Yes in S35), the communication control section 312 proceeds to the process of S36. Conversely, in a case where the condition “i−k<0” is not satisfied (No in S35), the communication control section 312 proceeds to the process of S37.

### (S36)

In S36, the communication control section 312 performs network coding on the packet Pᵢ and a packet Pᵢ₋₁ received by the light sending and receiving section 10 immediately prior to the reception of the packet Pᵢ, to generate packet Pᵢ+packet Pᵢ₋₁, which is the first coded information. In addition, the communication control section 312 sets the forced-sending time tᵢ. The forced-sending time tᵢ set in this case is a time obtained by adding, to the time t_{now} of judgment in S35, the second predetermined time Tₒ and the first predetermined time T_{Loss} which corresponds to the second coded information containing the packet Pᵢ. After the end of the process of S36, the communication control section 312 carries out the process of S30 again.

### (S37)

In S37, the communication control section 312 retrieves a packet Pᵢ₋ₖ from the storage section 32. The packet Pᵢ₋ₖ is a packet having a reception ordinal number of “i-k”. The communication control section 312 then performs network coding on the packet Pᵢ₋ₖ and packet Pᵢ+packet Pᵢ₋₁, which is the first coded information. The communication control section 312 thus generates packet Pᵢ₋ₖ+packet Pᵢ+packet Pᵢ₋₁, which is the second coded information.

Further, after clearing the setting of the forced-sending time tᵢ₋ₖ, the communication control section 312 sets a new forced-sending time tᵢ₋ₖ₊₁. The forced-sending time tᵢ₋ₖ is a forced-sending time used in a case where the packet Pᵢ₋ₖ+packet Pᵢ+packet Pᵢ₋₁, which is the second coded information, is not sent at the time at which the second coded information should be originally sent. The new forced-sending time tᵢ₋ₖ₊₁ is time obtained by adding, to the time t_{now} of judgment in S35, the second predetermined time Tₒ and the first predetermined time T_{Loss} which corresponds to the second coded information containing the packet Pᵢ₋ₖ.

After the end of the process of S37, the communication control section 312 carries out the process of S30 again. Thereafter, the communication control section 312 repeatedly carries out each of the processes of S30 to S37.

### <Example Advantage Produced by Free-Space Optical Communication System 200 and Each of Free-Space Optical Communication Apparatuses 3 and 4>

In the free-space optical communication apparatuses (first free-space optical communication apparatus 3 and second free-space optical communication apparatus 4) in accordance with the present example embodiment and the free-space optical communication system 200 containing these free-space optical communication apparatuses, in a case of a failure to send either (i) the first packet or the first coded information or (ii) the second coded information from the light sending and receiving means, the communication control means is configured to cause the light sending and receiving means to send information unsent due to the failure, after a second predetermined time elapses from a point in time at which the information unsent should be originally sent.

This eliminates the omission of sending in the light sending and receiving means. It is therefore possible for the decoding means to reliably restore a packet which has once attenuated or once been lost due to fading or the like. It is therefore possible to increase the reliability of free-space optical communication to a greater degree, by more effectively reducing the occurrence of burst errors.

### [Software Implementation Example]

Some or all of the functions of each of the free-space optical communication apparatuses 1 and 2 may be implemented by hardware such as an integrated circuit (IC chip), or may be implemented by software.

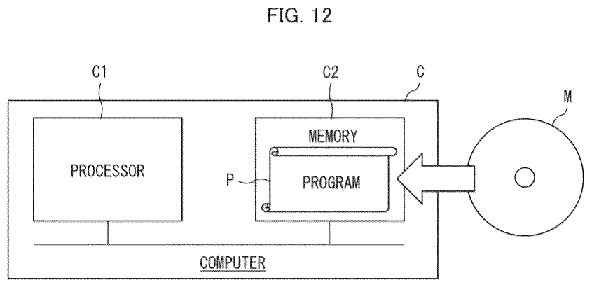

In the latter case, the free-space optical communication apparatuses 1 and 2 are each implemented by, for example, a computer that executes instructions of a program that is software implementing the foregoing functions. An example (hereinafter, computer C) of such a computer is illustrated in FIG. 12. The computer C includes at least one processor C1 and at least one memory C2. The memory C2 has recorded thereon a program P for causing the computer C to operate as the free-space optical communication apparatuses 1 and 2. The processor C1 of the computer C retrieves and executes the program P from the memory C2, so that the functions of the free-space optical communication apparatuses 1 and 2 are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be recorded on a non-transitory, tangible recording medium M capable of being read by the computer C. Examples of such a recording medium M can include a tape, a disk, a card, a semiconductor memory, and a programmable logic circuit. The computer C can obtain the program P via such a recording medium M. Alternatively, the program P can be transmitted through a transmission medium. Examples of such a transmission medium can include a communication network and a broadcast wave. The computer C can obtain the program P also via such a transmission medium.

### [Additional Remark 1]

The present invention is not limited to the foregoing example embodiments and variation, but may be altered in various ways by a skilled person within the scope of the claims. For example, the present invention also encompasses, in its technical scope, any example embodiment derived by appropriately combining technical means disclosed in the above example embodiments and variation.

### [Additional Remark 2]

The whole or part of the example embodiments and variation disclosed above can be described as, but not limited to, the following supplementary notes.

### (Supplementary Note 1)

A free-space optical communication apparatus including: a light sending and receiving means for sending and receiving communication light; and

a communication control means for controlling packet communication conducted via the light sending and receiving means,

the communication control means being configured to
cause the light sending and receiving means to send either a first packet or first coded information, the first packet being received by the light sending and receiving means, the first coded information containing the first packet and being generated by network coding, and
then cause the light sending and receiving means to send second coded information generated by network coding, the second coded information containing the first packet and a second packet, the second packet being received by the light sending and receiving means at a point in time at which a first predetermined time elapses from a point in time at which either the first packet or the first coded information is sent.

### (Supplementary Note 2)

The free-space optical communication apparatus described in supplementary note 1, further including an estimating means for estimating a duration time of fading which occurs during the packet communication, by measuring signal strengths of a plurality of packets received by the light sending and receiving means,

the communication control means being configured to set the first predetermined time to an estimated duration which is the duration time of fading estimated by the estimating means.

### (Supplementary Note 3)

The free-space optical communication apparatus described in supplementary note 1, further including an estimating means for estimating a duration time of fading which occurs during the packet communication, by measuring signal strengths of a plurality of packets received by the light sending and receiving means,

the communication control means being configured to set the first predetermined time to a sum of an estimated duration time estimated by the estimating means and at least one selected from the group consisting of an adjustment time and a synchronization time, the adjustment time being time required for adjustment of an angle of an antenna of the light sending and receiving means, the synchronization time being time required for synchronization of a communication signal of the packet communication

### (Supplementary Note 4)

The free-space optical communication apparatus described in supplementary note 1, in which the communication control means is configured to, in a case of a failure to send either (i) the first packet or the first coded information or (ii) the second coded information, cause the light sending and receiving means to send information unsent due to the failure, after a second predetermined time elapses from a point in time at which the information unsent should be originally sent.

### (Supplementary Note 5)

A free-space optical communication system including a plurality of free-space optical communication apparatuses,

at least two free-space optical communication apparatuses of the plurality of free-space optical communication apparatuses including

a light sending and receiving means for sending and receiving communication light; and

a communication control means for controlling packet communication conducted via the light sending and receiving means,

the communication control means being configured to
cause the light sending and receiving means to send either a first packet or first coded information, the first coded information containing the first packet and being generated by network coding, and
then cause the light sending and receiving means to send second coded information generated by network coding, the second coded information containing the first packet and a second packet, the second packet being received by the light sending and receiving means at a point in time at which a first predetermined time elapses from a point in time at which either the first packet or the first coded information is sent.

### (Supplementary Note 6)

The free-space optical communication system described in supplementary note 5, in which each of the at least two free-space optical communication apparatuses further includes
a decoding means which is capable of decoding an unprocessed packet, the first coded information, and the second coded information, the unprocessed packet being a packet not having undergone network coding performed by the communication control means, and
the decoding means of one free-space optical communication apparatus of the at least two free-space optical communication apparatuses is configured to decode the unprocessed packet, the first coded information, and the second coded information which are sent from the light sending and receiving means of another free-space optical communication apparatus of the at least two free-space optical communication apparatuses.

### (Supplementary Note 7)

A free-space optical communication method including a packet communication control carried out via a light sending and receiving means for sending and receiving communication light,

the packet communication control including
causing the light sending and receiving means to send either a first packet or first coded information, the first coded information containing the first packet and being generated by network coding, and
then causing the light sending and receiving means to send second coded information generated by network coding, the second coded information containing the first packet and a second packet, the second packet being received by the light sending and receiving means at a point in time at which a first predetermined time elapses from a point in time at which either the first packet or the first coded information is sent.

### (Supplementary Note 8)

A program for causing a computer to operate as the free-space optical communication apparatus described in any one of supplementary notes 1 to 4, the program causing the computer to function as the communication control means and the estimating means.

### (Supplementary Note 9)

A free-space optical communication apparatus comprising: a light sending and receiving section configured to send and receive communication light; and at least one processor, the at least one processor carrying out a communication control process of controlling packet communication conducted via the light sending and receiving section, in the communication control process, the at least one processor causes the light sending and receiving section to send either a first packet or first coded information, the first packet being received by the light sending and receiving section, the first coded information containing the first packet and being generated by network coding, and then causes the light sending and receiving section to send second coded information containing the first packet and a second packet and generated by network coding, the second packet being received by the light sending and receiving section at a point in time at which a first predetermined time elapses from a point in time at which either the first packet or the first coded information is sent.

It should be noted that this free-space optical communication apparatus may further include a memory, and this memory may have stored therein a program for causing the at least one processor to perform the communication process and the communication control process. In addition, a computer-readable, non-transitory, and tangible recording medium may have this program recorded thereon.

### REFERENCE SIGNS LIST

1, 2: Free-space optical communication apparatus
3: First free-space optical communication apparatus (another free-space optical communication apparatus)
4: Second free-space optical communication apparatus (one free-space optical communication apparatus)
10, 20: Light sending and receiving section (light sending and receiving means)
11, 312, 412: Communication control section (communication control means)
311, 411: Estimating section (estimating means)
313, 413: Decoding section (decoding means)
100, 200: Free-space optical communication system
Pᵢ₋ⱼ: Given packet (first packet)
Pᵢ: Packet (second packet)
Pᵢ′: Second coded information
T_{Link}: Synchronization time
T_{Loss}: First predetermined time
T_{Point}: Adjustment time
T_{Optic}: Estimated duration time
Tₒ: Second predetermined time

1. A free-space optical communication apparatus comprising:
a light sending and receiving section configured to send and receive communication light; and
at least one processor,
the at least one processor carrying out a communication control process of controlling packet communication conducted via the light sending and receiving section,
in the communication control process, the at least one processor
causes the light sending and receiving section to send either a first packet or first coded information, the first packet being received by the light sending and receiving section, the first coded information containing the first packet and being generated by network coding, and
then causes the light sending and receiving section to send second coded information containing the first packet and a second packet and generated by network coding, the second packet being received by the light sending and receiving section at a point in time at which a first predetermined time elapses from a point in time at which either the first packet or the first coded information is sent.

2. The free-space optical communication apparatus according to claim 1, wherein
the at least one processor further carries out
an estimating process of estimating a duration time of fading which occurs during the packet communication, by measuring signal strengths of a plurality of packets received by the light sending and receiving section, and
in the communication control process, the at least one processor sets the first predetermined time to an estimated duration which is the duration time of fading estimated through the estimating process.

3. The free-space optical communication apparatus according to claim 1, wherein
the at least one processor further carries out
an estimating process of estimating a duration time of fading which occurs during the packet communication, by measuring signal strengths of a plurality of packets received by the light sending and receiving section, and
in the communication control process, the at least one processor sets the first predetermined time to a sum of an estimated duration time estimated through the estimating process and at least one selected from the group consisting of an adjustment time and a synchronization time, the adjustment time being time required for adjustment of an angle of an antenna of the light sending and receiving section, the synchronization time being time required for synchronization of a communication signal of the packet communication.

4. The free-space optical communication apparatus according to claim 1, wherein
in the communication control process, in a case of a failure to send, from the light sending and receiving section, either (i) the first packet or the first coded information or (ii) the second coded information, the at least one processor causes the light sending and receiving section to send information unsent due to the failure, after a second predetermined time elapses from a point in time at which the information unsent should be originally sent.

5. A free-space optical communication system comprising a plurality of free-space optical communication apparatuses,
at least two free-space optical communication apparatuses of the plurality of free-space optical communication apparatuses each including:
a light sending and receiving section configured to send and receive communication light; and
at least one processor,
the at least one processor carrying out a communication control process of controlling packet communication conducted via the light sending and receiving section,
in the communication control process, the at least one processor
causes the light sending and receiving section to send either a first packet or first coded information, the first coded information containing the first packet and being generated by network coding, and
then causes the light sending and receiving section to send second coded information containing the first packet and a second packet and generated by network coding, the second packet being received by the light sending and receiving section at a point in time at which a first predetermined time elapses from a point in time at which either the first packet or the first coded information is sent.

6. The free-space optical communication system according to claim 5, wherein
the at least one processor of each of the at least two free-space optical communication apparatuses further carries out
a decoding process in which an unprocessed packet, the first coded information, and the second coded information are capable of being decoded, the unprocessed packet being a packet not having undergone network coding performed through the communication control process, and
in the decoding process of one free-space optical communication apparatus of the at least two free-space optical communication apparatuses, the at least one processor decodes the unprocessed packet, the first coded information, and the second coded information which are sent from the light sending and receiving section of another free-space optical communication apparatus of the at least two free-space optical communication apparatuses.

7. A free-space optical communication method comprising at least one processor carrying out a packet communication control process via a light sending and receiving section for sending and receiving communication light,
in the packet communication control process, the at least one processor
causing the light sending and receiving section to send either a first packet or first coded information, the first coded information containing the first packet and being generated by network coding, and
then causing the light sending and receiving section to send second coded information containing the first packet and a second packet and generated by network coding, the second packet being received by the light sending and receiving section at a point in time at which a first predetermined time elapses from a point in time at which either the first packet or the first coded information is sent.

8. A computer-readable non-transitory recording medium having recorded thereon a program for causing a computer to operate as the free-space optical communication apparatus according to claim 1, the program causing the computer to carry out the communication control process.
